(19) United States
(12) Patent Application Publication
(10) Pub. No.: US 2020/0276605 A1
(43) Pub. Date: Sep. 3, 2020

(54) INSTALLATION AND METHOD FOR COATING OBJECTS

(71) Applicant: EISENMANN SE, Böblingen (DE)

(72) Inventors: Julian Bubek, Böblingen (DE); Dennis Weik, Althengststett (DE); Urs Gümbel, Nürtingen (DE); Patrick Wohnsiedler, Stuttgart (DE)

(21) Appl. No.: 16/647,112

(22) PCT Filed: Sep. 10, 2018
(86) PCT No.: PCT/EP2018/074316

§ 371 Date: Mar. 13, 2020

(30) Foreign Application Priority Data
Sep. 14, 2017 (DE) 10 2017 121 340.6

(51) Int. Cl. B05B 14/43; B05B 16/40; B05B 16/60

(52) U.S. Cl. CPC B05B 14/43; B05B 16/60; B05B 16/40

(57) ABSTRACT

An installation for coating objects, more particularly vehicle bodies and/or vehicle body parts, having a coating booth having an air supply chamber and an application area which are spatially separated by a flow-permeable booth ceiling. An air system is set up in such a way that conditioned air can be supplied to the air supply chamber and said conditioned air flows further through the application area as booth air. In the application area, at least one application unit is arranged, wherein in the application area overspray occurs that is taken up by and carried in the booth air. The air system includes a flow guiding unit having a flow rectifier structure that is set up in such a way that the flow of the air supplied to the air supply chamber is homogenised. A method for coating objects with an installation of this kind is also provided.

The invention relates to a plant for coating objects, in particular vehicle bodies and/or vehicle body parts with
a) a coating booth comprising an air supply space and an application area, which are spatially separated by a flow-permeable booth ceiling;
b) an air system configured such that conditioned air can be supplied to the air supply space and this conditioned air continues to flow as booth air through the application area;
   wherein
c) at least one application device is arranged in the application area and overspray occurs in the application area, which is taken up and carried along by the booth air.

Furthermore, the invention relates to a method for coating objects, in particular vehicle bodies and/or vehicle body parts.

In the manual or automatic application of paints to objects, a partial flow of the paint, which generally contains both solids and/or binders and solvents, is not applied to the object. This partial flow is called “overspray” by experts. The overspray is captured by the booth air flow in the treatment booth and is supplied to a separating unit so that the air can be returned to the coating booth after suitable conditioning if necessary.

In order to obtain reproducible painting results, it is desirable in coating booths that the flow velocity at which the booth air flows from top to bottom through the application area is largely constant over the area of the application area and that the flow is homogeneous overall.

In order to achieve this, the air supply space in plants known from the market has a relatively large volume so that the air can calm on its way through the air supply space to the flow-permeable booth ceiling and swirling and turbulence can be dissolved. The required volume is achieved by the build height of the air supply space.

In such systems, the height of the application area between the booth ceiling and a booth floor is, for example, about 4.5 m and the height of the air supply space between a ceiling of the air supply space and the booth ceiling is, for example, about 3.0 m.

Below the application area there is usually a lower plant part, in which there is a relaxation area for the booth air loaded with overspray, which leads to a separating area also located in the lower plant part and a separating device received there, with which the booth air can be freed from the overspray. The relaxation area serves the purpose of giving the booth air loaded with overspray time to calm in terms of flow, since it should reach the separating device as a flow as homogeneous as possible. On its way through the application area, the booth air is swirled again by the superstructures present there, especially by the application equipment in the form of painting robots and by the present conveyor technology, but also by the objects to be painted themselves. Overall, the relaxation area serves to reduce and at best eliminate flows in the longitudinal direction of the coating booth.

The lower plant part is, for example, approximately 4.0 m high in plants known from the market and extends from the booth floor to a set-up surface of the coating booth.

The total height of such a coating booth, without further superstructures on the air supply space, is thus approximately 11.50 m, wherein the height of the application area is approximately 40% of the total height, the height of the air supply space is approximately 66% of the height of the application area and the height of the relaxation area is approximately 33% of the height of the application area. A coating booth usually comprises an elaborate steel construction.

These conditions also apply to other total heights of coating booths. Due to the overall dimensions and in particular the overall height of the coating booths, a large amount of steel material is therefore required, which increases the overall costs.

There is now a market demand for plants with coating booths with lower build heights. The application area can thereby only be limited in height to a very small extent. Also the air supply space is not suitable in principle to save overall height, because it must provide a sufficient flow path.

It is therefore the object of the invention to provide a plant and a method of the kind mentioned above which take these thoughts into account.

This object is solved in the case of a plant mentioned at the beginning in that
d) the air system comprises a flow guiding device with a flow straightening structure configured such that the flow of the air supplied to the air supply space is homogenized.

According to the invention, it has been recognized that, contrary to the opinion explained above, it is possible to save height in the air supply space if a flow straightening structure with the effect explained above is provided. In this case, the supplied air does not need a long flow path in order to flow sufficiently homogeneously into the application area.

It is thereby particularly favourable if the booth air flows into the application area as a substantially laminar flow.

It is advantageous if the flow straightening structure is arranged on the booth ceiling of the application area and thereby abuts the booth ceiling or is arranged at a distance from the booth ceiling or is integrated into the booth ceiling.

The flow straightening structure is preferably arranged in the air supply space or in the application area.

It is particularly effective if the flow straightening structure comprises a plurality of flow passages.

A homogeneous flow is achieved if the flow passages are polygonal, rectangular, circular or elliptical in cross-section.

The flow straightening structure is particularly effective when flow passages are hexagonal in cross-section.

The flow straightening structure can be easily installed if it is formed as a flexible or rigid flow mat.

Preferably, the flow straightening structure comprises a honeycomb structure with a honeycomb diameter between approximately 3 mm and approximately 20 mm and a height between approximately 3 mm and approximately 300 mm.

The flow straightening structure can advantageously be made of metal or a metal alloy, in particular aluminium, of a fibre composite material, in particular of an aramide paper impregnated with phenolic resin, or of plastic, in particular of polycarbonate or polyetherimide.

To ensure good and uniform penetration of the application area with booth air, it is advantageous if the flow straightening structure extends over at least 80% of the width of the application area and over substantially the longitudinal extension of the application area.

In addition, it can be advantageous if the flow guiding device comprises a flow guiding structure configured such that air supplied to the air supply space is guided in the direction towards the flow straightening structure. In this way, the required flow path in vertical direction can be shortened further if necessary.

It is advantageous if the flow guiding structure divides the air supply space in the longitudinal direction into at least two partial spaces.

This is particularly advantageous if the air system is configured such that conditioned air is supplied to the air supply space from the side in relation to the longitudinal direction of the coating booth. By means of the flow guiding structure it is then prevented that flows moving towards each other mix, which would lead to undesired strong swirling in the air supply space, which, if necessary, cannot be calmed without further measures until the air enters the application area.

The principle explained above can be used particularly advantageously if the coating booth comprises a separating area into which booth air loaded with overspray flows and in which a separating device for separating overspray is arranged, by means of which a large part of at least the solids of the overspray can be separated from the booth air.

For effective guiding of the booth air loaded with overspray to the separating area, it is advantageous if a relaxation area is arranged between the separating area and the application area, via which booth air loaded with overspray is guided to the separating device in the separating area.

If the separating device is associated with one or more conveying fans that extract booth air out of the relaxation area to the separating device and through it, the relaxation area in turn can be reduced in height because the flow is directed and homogenized by the additional active suction.

It is structurally favourable if the height of the application area defined by the distance between the booth ceiling and a booth floor is approximately 50% to 75% of the total height of the coating booth defined by the distance between a ceiling of the air supply space, referred to as the plenum ceiling, and the set-up surface of the coating booth.

It is also advantageous if the height of the air supply space defined by the distance between the plenum ceiling and the booth ceiling is approximately 5% to 25% of the height of the application area.

Preferably, the plant comprises a separating area and a relaxation area with a height of the relaxation area which is defined by the distance between a booth floor of the application area and the separating area and is approximately 5% to 25% of the height of the application area.

The above-mentioned object is also solved in the case of a method of the type mentioned at the beginning, in that a plant having some of all of the features described above is used.

Embodiments of the invention are explained in more detail below based on the drawings.

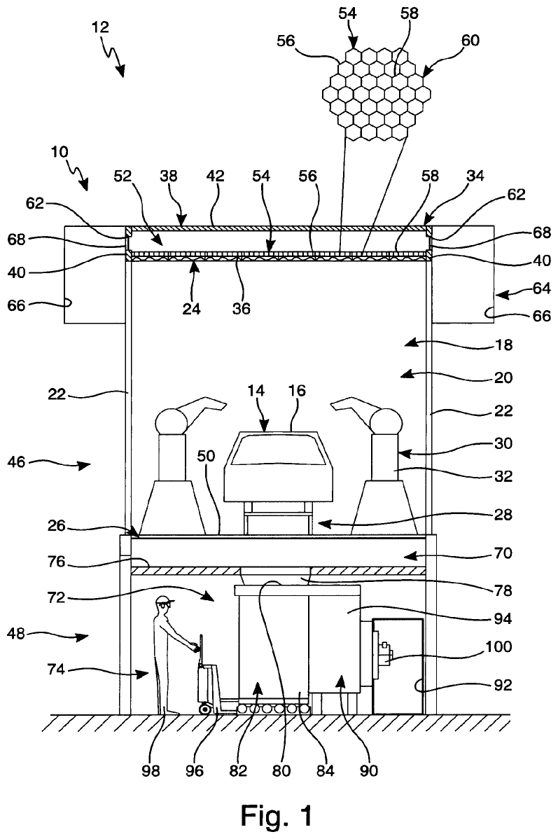

FIG. 1 shows a plant for coating objects with a coating booth in a front view, wherein by means of an air system conditioned air can be supplied to an air plenum, the conditioned air continuing to flow as booth air through an application area, and the air system comprises a flow guiding device with which the flow of the air supplied to the air plenum can be homogenized;

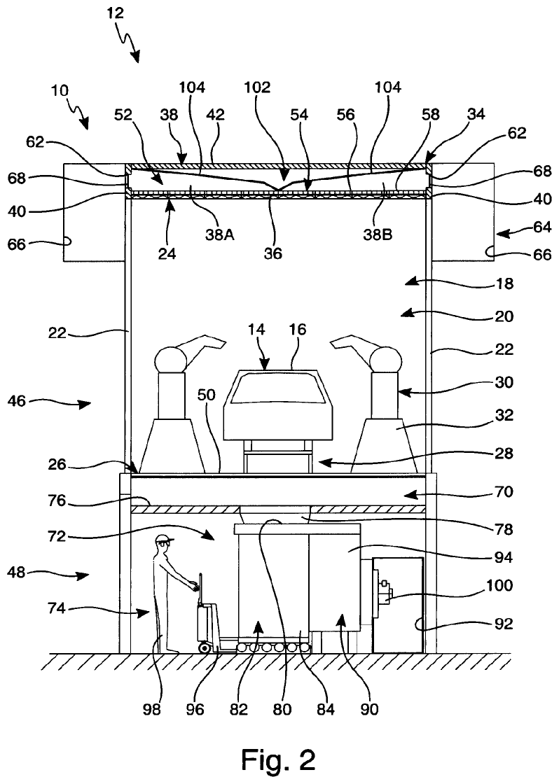

FIG. 2 shows a front view of a coating booth of a plant for coating objects with a modified flow guiding device;

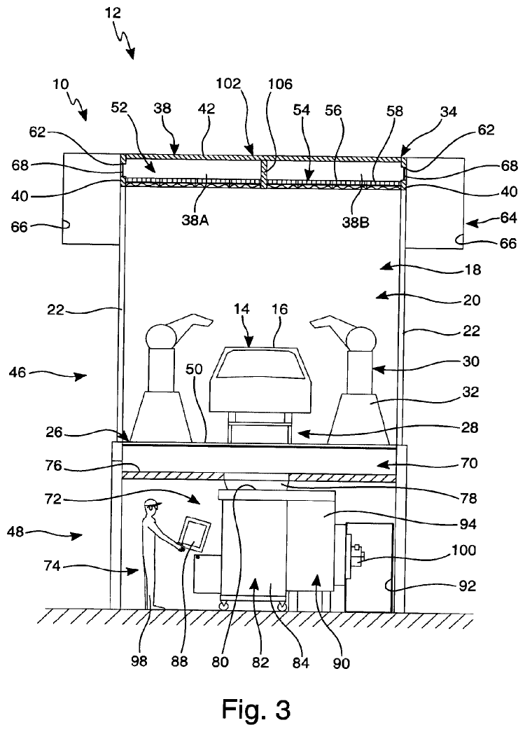

FIG. 3 shows a front view of a coating booth of a plant for coating objects with a flow guiding device which has been modified again;

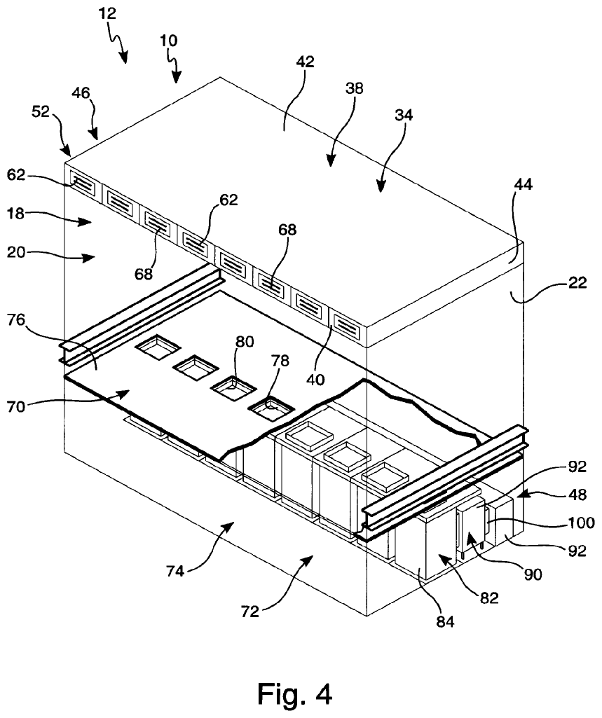

FIG. 4 shows a perspective view of the coating booths according to FIGS. 1 to 3, in which an adjusting device of the air system is provided, by means of which the supply of air into the air plenum can be adjusted.

FIG. 1 shows a coating booth 10 of a plant, referenced to as a whole by 14, for the coating of objects 14. Vehicle bodies 16 being painted in the coating booth 10 are shown as an example of objects 14 to be coated and of the coating process. Other objects, in particular vehicle body parts or add-on parts for vehicle bodies, but also other objects can be coated in the coating booth 10.

The coating booth 10 comprises an application area 18, which in the present embodiment is defined by an application tunnel 20, which is limited by vertical side walls 22, a booth ceiling 24 and a booth floor 26, but is open at the end faces.

The vehicle bodies 16 are transported from the entrance side of the application tunnel 20 to its exit side by a conveyor system 28, which is received in the application area 18 and is known in and of itself. Inside the application tunnel 20 there are application devices 30 in the form of multi-axis application robots 32, as they are also known in and of themselves. By means of the application robots 32, the vehicle bodies 16, or other objects to be coated 14, can be coated with the corresponding material. Overspray occurs in the application area 18 when coating material is applied to the objects 14.

The booth ceiling 24 is flow-permeable and separates the application area 18 spatially, i.e. not fluidically, from an air supply space 34 arranged above it, which is referred to as an air plenum among experts; for this reason, the term air plenum 34 will also be used here. The booth ceiling 24 as such is configured as a filter ceiling 36 in the present embodiment, as is known in and of itself.

The air plenum 34 is bounded by a downwardly open plenum housing 38 with plenum side walls 40, a plenum ceiling 42 and plenum end walls 44, wherein only one of the plenum end walls 44 is shown in FIG. 4. FIG. 4 also shows at the ends of the coating booth 10 respective I-beams of the steel structure mentioned at the beginning, which among other things support the grating 50 not shown and are not specially marked with reference signs.

Conditioned air can be supplied to the air plenum 34 by means of an air system 46, the conditioned air flowing through the booth ceiling 24 as booth air further down through the application area 18. The overspray in the application area 18 is taken up and carried along by the booth air.

The application tunnel 20 is open towards the bottom towards a plant part 48 arranged below it such that the booth floor 26 is also flow-permeable. For this purpose, the booth floor 26 is configured as a grating 50 which can be walked on. In the lower plant part 48, overspray particles carried along by the booth air are separated from the booth air. This will be discussed in more detail below.

The more homogeneous and uniform the flow of booth air coming from the air plenum 34 through the application area 18 in relation to its base area is, the more effectively and reproducibly the objects 12 can be coated with coating material. In particular, the booth air flows as a laminar flow along the objects 12 to be coated, so that substantially comparable conditions prevail at the objects 12 over the duration of the coating process.

In addition, the booth air can take up and carry away the overspray that occurs there. It is of particular importance that the flow of booth air enters and passes through the entire width of the application area 18 substantially homogeneous and uniform.

For this purpose, the air system 46 comprises a flow guiding device 52 for homogenizing the booth air flowing from the air plenum 34 into the application area 18. The flow guiding device 52 comprises a flow straightening structure 54 configured such that the flow of the air supplied to the air plenum 34 is homogenized. Overall, the flow guiding device 52 thus provides a flow straightener and causes a turbulent air flow in the air plenum 34 in the form of booth air to flow into the application area 18 with a substantially unidirectional laminar air flow and a substantially uniform flow velocity. In the optimum case, the booth air is a completely unidirectional laminar flow when it flows into application area 18. The booth air flows into the application area 18 over at least 80% of the width of the application area 18 and substantially over the longitudinal extension of the application area 18. The flow straightening structure 54 on the booth ceiling 24 also extends or acts over this area.

In the present embodiments, a flow straightening structure 54 is formed by a flow mat 56 with a plurality of flow passages 58, which can be flexible or largely rigid. Irrespective of whether the flow straightening structure 54 is formed as a mat, it comprises a plurality of flow passages in any case.

The flow mat 56 is arranged in the air plenum 34 in the embodiments shown in the figures. The flow straightening structure 54, i.e. here the flow mat 56, is arranged on the side of the booth ceiling 24 facing the air plenum 34, in the embodiments shown here therefore on the side of the filter ceiling 36 facing the air plenum 34. The flow mat 56 thereby abuts the booth ceiling 24 or rather the filter ceiling 36. In a modification, a distance can also remain between the flow straightening structure 54 and the booth ceiling 24. The flow mat 56 covers the area of the booth ceiling 24.

In the embodiments shown in the figures, the flow mat 56 is one-piece; in a variation not shown, the flow mat 56 can also be composed of several mat sections. In a modification, the flow straightening structure 54, in this case the flow mat 56, can also be arranged on the side of the booth ceiling 24 or rather the filter ceiling 36 that is away from the air plenum 34. Alternatively, the flow straightening structure 54 can also be integrated into the booth ceiling 24. For this purpose, in the present configurations, for example, the filter ceiling 36 and the flow mat 56 can be combined to form the booth ceiling 24 by filling the individual flow passages 58 of the flow mat 56 with a suitable filter material. The flow mat 56 can also be used as a support for a filter ceiling 36.

The flow straightening structure 54 is configured as a honeycomb grid in the present embodiments and defines a honeycomb structure 60, which is only shown in FIG. 1 in an enlargement and in which the flow passages 58 have a corresponding hexagonal cross-section. However, cross-sections of the flow passages 58 which deviate from this are also possible, in particular rectangular, especially square, as well as circular or elliptical cross-sections. In general, cross-sections other than hexagonal polygonal cross-sections or otherwise curved walls of the flow passages 58 can also be formed. Various flow passages 58 with different cross-sections and dimensions can also be combined with each other in the flow straightening structure 54.

The flow mat 56 with honeycomb structure 60 can, for example, have a honeycomb diameter between approximately 3 mm and approximately 20 mm and a height between approximately 3 mm and approximately 300 mm. The flow mat 56 with honeycomb structure 60 can be made of a metal or a metal alloy, especially of aluminium. Alternatively, the flow mat 56 with honeycomb structure 60 can be made of fibre composites, for example of aramid paper impregnated with phenolic resin. Other materials are plastics, in particular plastics such as polycarbonates or polyetherimides. In the case of a flow mat 56 made of polycarbonate, a good homogenization of the booth air flow could be achieved when a honeycomb diameter between approximately 3.5 mm and approximately 7 mm with a height of 3 mm to 300 mm was chosen. A honeycomb diameter of approximately 4.2 mm at a height between 5 mm and 300 mm was particularly effective with a flow mat 56 made of a polyetherimide.

The air system 46 is configured such that the air plenum 34 is supplied with conditioned air from the side in relation to the longitudinal direction of the coating booth 10. For this purpose, the plenum housing 38 has multiple supply air passages 62 in the plenum side walls 40, which supply air passages 62 are connected to a supply system 64 of the air system 46. As can be seen in FIG. 4, the multiple supply air passages 62 are arranged evenly spaced along the plenum side walls 40.

FIGS. 1 to 3 illustrate that all supply air passages 62 of each plenum side wall 40 are connected as a group to one supply air channel 66 of the supply system 64 in each case. The supply air channels 66 are fed with conditioned supply air; for the sake of clarity, the components and parts required for this, which are known in and of themselves, such as fans, lines, valves and the like, as well as preceding conditioning devices, are not shown.

The passage cross-sections of the supply air passages 62 of the plenum housing 38 can be adjusted by means of adjusting means 68, so that the supply air passages 62 can be either blocked or opened up to a maximum passage cross-section. In the present embodiments, the adjusting means 68 are configured as sliders. Generally, pressure losses and pressure differences in the air plenum 34 are compensated for by manually adjusting all adjusting means 68 when the coating booth 10 is installed.

The adjusting means 68 can also be adjusted by a motor. The adjusting means 68 can then be controlled individually or in control groups by means of a control unit not shown separately. In this way, pressure losses or pressure differences in the air plenum or over the area of the application area 18 can be compensated. The flow profile of the booth air downstream of the booth ceiling 24 can be measured with a flow sensor technology not shown here, which communicates with the control unit. In this case it is possible to establish a feedback between the actual flow conditions and the flow setting.

The booth air now flows as a substantially unidirectional laminar flow from the air plenum 34 into the application area 18, flows through this area and then flows as booth air loaded with overspray into the lower plant part 48 and there initially into a relaxation area 70, which extends along the longitudinal extension of the application area 18. The booth air loaded with overspray is guided via this relaxation area 70 to a separating device 72, which is located in a separating area 74 of the lower plant part 48, the separating area 74 adjoining the relaxation area 70 in terms of flow.

Thus, a coating booth 10 basically comprises an air supply space 34, an application area 18, a relaxation area 70 and a separating area 74.

In order to prevent or at least reduce swirling and cross flows in the application area 18, the parts and components of the conveyor system 28 can be provided with flow-impermeable covers.

The relaxation area 70 is configured as a guide channel 76 of the flow guiding device 52, which opens at its underside into several suction channels 78, which in turn each end in a connecting piece 80. In the present embodiments, the guide channel 76 has a constant cross-section in the downward direction and ends in a flat, horizontal floor with the suction channels 78. In the case of a variation not shown here, the guide channel 76 can also be tapered downwards towards the suction channels 78.

The separating device 72 comprises several filter devices 82, one of which is each connected to a connecting piece 80 of the guide channel 76. In the embodiments shown in FIGS. 1 and 2, the filter devices 82 are configured as disposable filter modules 84 of a first type and are used and exchanged as a constructional unit. In the embodiment according to FIG. 3, the filter devices 82 comprise a stationary filter housing 86, in which exchangeable disposable filter modules 88 of a second type are received. In both embodiments according to FIGS. 1 and 2 or 3 respectively, the filter devices 82 can also be used in the coating booths 10 shown in FIG. 3 or 1 respectively and 2.

The suction channels 78 extend over about 20% to 30% of the width of the application area 18 and have a substantially square cross-section in the vertical direction. In the longitudinal direction of the application area 18, the suction channels 78 are provided at intervals so that the filter devices 82 can be positioned as close together as possible.

In the disposable filter modules 84 or 88, the booth air loaded with overspray flows through a filter unit with a filter structure on which the paint overspray is separated. In total, each disposable filter module 84 or 88 respectively is configured as an exchangeable unit.

The booth air, now substantially freed of overspray particles, flows from the filter devices 82 into an intermediate channel 90 in each case, via which it then enters a collective flow channel 92.

The booth air can be fed via the collective flow channel 92 to a further processing and conditioning and then, in a circuit not shown here, can be fed as conditioned air into the supply air channels 66 of the supply system 64 and thus into the air plenum 34, from where it flows back into the application area 18 from above.

If the booth air is indeed not yet sufficiently freed from overspray particles by the existing filter devices 82, further filter stages 94 can be installed downstream of the filter devices 82, to which the booth air is fed and in which, for example, electrostatic separators are also used, as are known in and of themselves. Such further filter stages can be provided in or in combination with the intermediate channels 90, for example.

Each disposable filter module 84 or 88 respectively is configured to take up a maximum quantity of paint, i.e. a limit load of overspray, depending on the build type of the disposable filter module 84 or 88 and the materials used for it. The quantity of paint already taken up can be monitored using a scale not shown specifically or determined by means of a differential pressure determination. The greater the load of the disposable filter module 84, 88 is, the greater the air resistance built up by the disposable filter module 84 or 88.

When a disposable filter module 84 or 88 reaches its maximum take-up capacity, the fully loaded disposable filter module 84 or 88 is moved out of the lower plant part 48 of the coating booth 10.

Each disposable filter module 84 of the first type forms a filter device 82, i.e. one that can be moved as a unit, for example, with the aid of a lifting vehicle 96 that is operated by an operator 98, as illustrated in FIGS. 1 and 2. For this purpose, the floor portion of the disposable filter module 84 or the filter device 82 formed by the disposable filter module 84 of the first type can be configured in its geometry and dimensions as a standardized support structure and, for example, according to the specifications of a so-called Euro pallet.

The depicted worker 98 with the lifting vehicle 96 is only intended to illustrate the manual work, without being shown true to scale.

The disposable filter modules 88 of the second type loaded with overspray are removed from the stationary filter housing 86 by a worker 98 and replaced by an unloaded disposable filter module 88. Alternatively, the filter housing 86 can also be movable and removed from the separating area 74 in order to replace one or more disposable filter modules 88 elsewhere.

Prior to this, the flow connection to the relevant filter device 82 with the guide channel 76 is closed by means of gate valves not shown specifically. This gate valve diverts the booth air to the filter devices 82 located next to the disposable filter module 84 or 88 to be exchanged, which assume its task until the replacement has been performed.

Then an empty, i.e. not loaded with overspray, disposable filter module 84 of the first type is placed in the operating position or an empty disposable filter module 88 of the second type is placed in the stationary filter housing 86 until it is seated in a flow-tight manner. The gate valve to the guide channel 76 is moved back to an open position so that the newly positioned disposable filter module 84 or 88 is flowed through by the booth air.

In a modification not shown, the replacement of one of the disposable filter modules 84 or 88 can be performed in an automated or at least semi-automated fashion.

The air system 46 comprises several conveying fans 100 arranged downstream of the filter devices 82. In the embodiments described here, one conveying fan 100 respectively is arranged at the transition of each intermediate channel 90 to the collection flow channel 92. The conveying fans 100 support the flow of the booth air through the application area 18 and form secondary conveying fans, which operate as a supplement to a primary conveying system of the air system 46 usually formed by a central fan device. Such secondary conveying fans 100 support in particular the removal of the booth air loaded with overspray from the relaxation area 70, whereby undesirable flows in the longitudinal direction of the coating booth 10 in the relaxation area 70 are at least reduced. The conveying power of the secondary conveying fans 100 can be controlled in coordination with the loading of the filter equipment 82.

If necessary, such supplementary secondary conveying fans 100 can also be dispensed with. Alternatively, such conveying fans 100 could also form the overall conveying system of the air system 46, which in this case is configured in a decentralized manner.

Such conveying fans 100 can be equipped with sensor technology or work together with sensor technology with which the flow pressure of the booth air flowing through the individual filter devices 82 can be detected. The conveying power of each conveying fan 100 can then be regulated with the associated control system depending on the local conditions and requirements.

With such conveying fans 100, the relaxation area 70 can manage with less height, since the flow is directed and homogenized by the active additional suction.

FIGS. 2 and 3 each show the coating booth 10 with a modified flow guiding device 52 comprising a flow guiding structure 102 in addition to the flow straightening structure 54.

In the embodiments shown here, the flow guiding structure 102 is upstream of the flow straightening structure 54 and has the task of guiding the air supplied to the air plenum 34 in the direction towards the flow straightening structure 54 and of effecting a pre-calming of the flow as best as possible. For this purpose, the plenum housing 38 is divided in a first approach by the flow guiding structure 102 in the longitudinal direction into two sub-spaces 38A, 38B, into which air flows in each case through the supply air passages 62 in the plenum housing 38. The two sub-spaces 38A, 38B are symmetrical to the central longitudinal axis of the air plenum 34.

This prevents the two air flows, which enter the air plenum 34 from both sides through the supply air passages 62 and thereby flow towards each other, from meeting in the air plenum 34, which can lead to sometimes violent swirling and turbulence, which may not be sufficiently homogenized by the flow straightening structure 54.

The flow guiding structure 102 shown in FIG. 2 is configured in the form of two flow baffles 104, each of which extends from the plenum side walls 40 from above the supply air passages 62 to the center in the longitudinal direction of the air plenum 34, where they abut the flow straightening structure 54. The flow baffles 104 extend in the longitudinal direction over the entire air plenum 34. On its way from the side to the center of the plenum, i.e. in the direction perpendicular to the longitudinal direction of the booth, the incoming air is already calmed at the flow baffles 104 and is moderately successively deflected towards the flow straightening structure 54 by the flow baffles 104. The flow straightening structure 102 shown in FIG. 3 is in the form of a vertical intermediate wall 106 extending longitudinally between the end faces of the plenum housing 38.

Other configurations of the flow guiding structure 102 can be provided and also, for example, flow guiding plates can be combined with the intermediate wall 106.

When considering the overall build height of a coating booth 10, reference is usually made to the ratio of the height of the application area 18 to the total height of the coating booth 10. The height of the application area 18 is thereby defined by the distance between the booth ceiling 24 and the booth floor 26. The total height of the coating booth 10 is defined by the distance between the top of the air plenum 34 and the set-up surface of the coating booth 10. Any superstructures that may be present outside on the top of the plenum housing 38 are to be neglected.

The flow straightening structure 54 now makes it possible that the vertical extension of the air plenum 34 can be considerably reduced compared to coating booths known on the market, as explained at the beginning.

As a result, the height of the application area 18 can be approximately 50% to 75% of the total height of the coating booth 10.

The height of the air plenum 34 from the plenum ceiling 42 of the air plenum 34 to the booth ceiling 24 can be 5% to 25% of the height of the application area 18.

The vertical extension of the relaxation area 70 can also be reduced. The height of the relaxation area 70 between the booth floor 26 and the separating area 74 can be 5% to 25% of the height of the application area 18.

The vertical extension of the separating area 74 can also be reduced. The height of the separating area 74 between the relaxation area 70 and the set-up surface of the coating booth 10 is at least less than 50% of the height of the application area 18.

The application area 18 of the coating booth 10 can be divided in the longitudinal direction into several application zones, which can either be spatially separated or openly connected to each other and in which different application processes are performed. For example, a top coat and a clear coat can be applied in two application zones in consecutive processes.

The separating area 74 can also be divided into several separating zones in the longitudinal direction of the coating booth 10, which can each be defined, for example, by one or more adjacent filter devices 82.

One or more such separating zones can then be assigned to a respective application zone. The air plenum 34 can also be divided into several plenum spaces in the longitudinal direction of the coating booth 10, so that, if necessary, each application zone can be supplied individually with booth air with a defined flow.

If several application zones are present, all of them can be fluidically connected to the relaxation area 70. It is possible, in the case of several application zones or only a single application area 18, that the relaxation area 70 is divided into two or more relaxation zones by one or more transverse partitions. If necessary, the transverse partitions can be provided with air passages, whose passage cross-section can also be adjustable so that the formed relaxation zones remain fluidically connected to each other. Such transverse partitions can at least reduce undesired flows in the longitudinal direction of the coating booth 10 and can be provided as an alternative or supplement to any secondary conveying fans 100 that may be present.

Such expansion zones can then in turn be fluidically connected with one or more separating zones or one or more filter devices 82 respectively.

What is claimed is:

1. A plant for coating objects comprising:
a) a coating booth comprising an air supply space and an application area, which are spatially separated by a flow-permeable booth ceiling;
b) an air system configured such that conditioned air can be supplied to the air supply space and this conditioned air continues to flow as booth air through the application area;
wherein
c) at least one application device is arranged in the application area and overspray occurs in the application area, which is taken up and carried along by the booth air,
and further wherein
d) the air system comprises a flow guiding device with a flow straightening structure configured such that the flow of the air supplied to the air supply space is homogenized.

2. The plant according to claim 1, wherein the flow straightening structure is configured such that the booth air flows into the application area as a substantially laminar flow.

3. The plant according to claim 1, wherein the flow straightening structure is arranged on the flow-permeable booth ceiling of the application area and thereby abuts the flow-permeable booth ceiling (24) or is arranged at a distance from the flow-permeable booth ceiling or is integrated into the flow-permeable booth ceiling.

4. The plant according to claim 3, wherein the flow straightening structure is arranged in the air supply space or in the application area.

5. The plant according to claim 1, wherein the flow straightening structure comprises a plurality of flow passages.

6. The plant according to claim 5, wherein the flow passages are polygonal, rectangular, circular or elliptical in cross-section.

7. The plant according to claim 6, wherein flow passages are hexagonal in cross-section.

8. The plant according to claim 1, wherein the flow straightening structure is formed as a flexible or rigid flow mat.

9. The plant according to claim 8, wherein the flow straightening structure comprises a honeycomb structure with a honeycomb diameter between approximately 3 mm and approximately 20 mm and a height between approximately 3 mm and approximately 300 mm.

10. The plant according to claim 1, wherein flow straightening structure is made of metal or a metal alloy, of a fibre composite material, or of plastic.

11. The plant according to claim 1, wherein the flow straightening structure extends over at least 80% of the width of the application area and over substantially the longitudinal extension of the application area.

12. The plant according to claim 1, wherein the flow guiding device comprises a flow guiding structure configured such that air supplied to the air supply space is guided in the direction towards the flow straightening structure.

13. The plant according to claim 12, wherein the flow guiding structure divides the air supply space in the longitudinal direction into at least two partial spaces.

14. The plant according to claim 1, wherein the air system is configured such that the conditioned air is supplied to the air supply space from the side in relation to the longitudinal direction of the coating booth.

15. The plant according to claim 1, wherein the coating booth comprises a separating area into which booth air loaded with overspray flows and in which a separating device for separating overspray is arranged, by means of which a large part of at least the solids of the overspray can be separated from the booth air.

16. The plant according to claim 15, wherein a relaxation area is arranged between the separating area and the application area, via which booth air loaded with overspray is guided to the separating device in the separating area.

17. The plant according to claim 16, wherein one or more conveying fans are associated with the separating device, wherein the conveying fans extract booth air out of the relaxation area to the separating device and through it.

18. A plant for coating objects comprising:
a) a coating booth comprising an air supply space and an application area, which are spatially separated by a flow-permeable booth ceiling;
b) an air system configured such that conditioned air can be supplied to the air supply space and this conditioned air continues to flow as booth air through the application area;
wherein
c) at least one application device is arranged in the application area and overspray occurs in the application area, which is taken up and carried along by the booth air,
and further wherein
d) the height of the application area defined by the distance between the booth ceiling and a booth floor is approximately 50% to 75% of the total height of the coating booth defined by the distance between a plenum ceiling of the air supply space and the set-up surface of the coating booth.

19. The plant according to claim 18, wherein the height of the air supply space defined by the distance between the plenum ceiling and the booth ceiling is approximately 5% to 25% of the height of the application area.

20. The plant according to claim 18, wherein the plant comprises a separating area into which booth air loaded with overspray flows and in which a separating device for separating overspray is arranged, by means of which a large part of at least the solids of the overspray can be separated from the booth air and a relaxation area arranged between the separating area and the application area, via which booth air loaded with overspray is guided to the separating device in the separating area and in that the height of the relaxation area defined by the distance between a booth floor of the application area and the separating area is approximately 5% to 25% of the height of the application area.

21. The plant according to claim 18 wherein the air system comprises a flow guiding device with a flow straightening structure configured such that the flow of the air supplied to the air supply space is homogenized.

22. A method for coating objects, wherein the coating is performed in a plant according to claim 1.
